(19) United States
(12) Patent Application Publication
(10) Pub. No.: US 2012/0069776 A1
(43) Pub. Date: Mar. 22, 2012

(54) SYSTEM AND METHOD TO INDICATE IP-BASED WIRELESS TELECOMMUNICATIONS SERVICE AVAILABILITY AND RELATED INFORMATION

(76) Inventors: Christopher E. Caldwell, Woodstock, GA (US); Janne P. Linkola, Espoo (FI); Omar Hassan, Kirkland, WA (US)

(21) Appl. No.: 13/073,944

(22) Filed: Mar. 28, 2011

Related U.S. Application Data
(63) Continuation of application No. 12/446,448, now abandoned.
(60) Provisional application No. 60/862,596, filed on Oct. 23, 2006.
(60) Provisional application No. 60/853,149, filed on Oct. 20, 2006.

(51) Int. Cl. H04W 4/02; H04W 4/00

(52) U.S. Cl. 370/271

(57) ABSTRACT

A service availability and pricing indication facility provides information about service options to a subscriber of mobile telecommunications services including IP-based services and non-IP-based services. The facility, which may be implemented in one or more components of a telecommunications service provider system, receives a notification including information based, at least partially, on a current location of the subscriber's mobile device. The facility uses this information to determine availability of an access point that allows for the mobile device to access IP-based services from the current location. If it is determined that at least one access point is available, the facility determines pricing associated with the subscriber utilizing the access point to conduct a communication using the mobile device and then provides information to the mobile device that allows the mobile device to present an indication of the availability of the access point and/or an indication of the pricing determination.

### CROSS-REFERENCE TO RELATED APPLICATIONS

This application is a Continuation of U.S. application Ser. No. 12/446,448 filed Apr. 20, 2009, which is a U.S. National Stage application of International Application No. PCT/US07/82160, entitled SYSTEM AND METHOD TO INDICATE IP-BASED WIRELESS TELECOMMUNICATIONS SERVICE AVAILABILITY AND RELATED INFORMATION, filed Oct. 22, 2007, which claims priority to U.S. Provisional Patent Application No. 60/862,596, filed Oct. 23, 2006, entitled “System and Method to Indicate IP-Based Wireless Telecommunications Service Availability,” and U.S. Provisional Patent Application No. 60/853,149, filed Oct. 20, 2006, entitled “Personalization of Telecom Service Based Upon User Location,” each of which is hereby incorporated by reference into the present application.

### BACKGROUND

In this digital age, modern telecommunication service providers and device manufacturers are increasingly relying on public and/or private IP networks, including the Internet, as a core part of their technology. For example, many telecommunications service providers now offer a suite of Voice over IP (“VoIP”) services, as well as various data services, that utilize IP networks and/or IP-based wireless access networks (e.g., access networks based on IEEE 802.16 (“WiMAX”), IEEE 802.20 Mobile Broadband Wireless Access (MBWA), Ultra Wideband (UWB), 802.11 wireless fidelity (“Wi-Fi”), Bluetooth, and similar standards) for at least part of their infrastructure. Likewise, device manufacturers are producing the next generation of mobile devices (e.g. wireless handhelds, wireless handsets, mobile phones, personal digital assistances, notebook computers, and similar devices) that are enabled to send and receive information utilizing IP-based telecommunications services. In fact, many of today's modern mobile devices are able to function as “dual-mode devices” that take advantage of both cellular network technologies and IP-based technologies.

Unlicensed Mobile Access (UMA) technology has developed as part of this trend to incorporate IP solutions into mobile device telecommunication systems. UMA technology has recently been accepted into Release 6 of the 3rd Generation Partnership Project (3GPP) and is also referred to as Generic Access Network (GAN) technology. In various implementation schemes, UMA allows wireless service providers to merge cellular networks (such as Global System for Mobile Communications (GSM) networks) and IP-based wireless networks into one seamless service (with one mobile device, one user interface, and a common set of network services for both voice and data). One goal of UMA is to allow subscribers to move transparently between cellular networks and IP-based wireless networks with seamless voice and data session continuity, much like they can transparently move between cells within the cellular network. Seamless in-call handover between the IP-based wireless network and the cellular network ensures that the user's location and mobility do not affect the services delivered to the user.

At an operational level, UMA technology effectively creates a parallel radio access network, the UMA network, which interfaces to the mobile core network using standard mobility-enabled interfaces. For example, UMA can replace a system's GSM radio technology on the lower protocol layers with a wireless LAN or similar technology. A call or other communication may be tunneled to the switch (e.g., mobile switching center or MSC) of a mobile service provider via an access point (e.g., a Wi-Fi access point connected to a modem via the Internet) and gateway (e.g., a UMA network controller). In many, cases, the mobile core network remains unchanged, making it much easier to maintain full service and operational transparency and allowing other aspects of the service infrastructure to remain in place. For example, in many systems that utilize UMA, the existing service provider's business support systems (BSS), service delivery systems, content services, regulatory compliance systems, and operation support systems (OSS) can support the UMA network without change. Likewise, service enhancements and technology evolution of the mobile core network apply transparently to both cellular access and UMA.

As the incorporation of IP solutions, such as UMA, into mobile device telecommunication systems expands, wireless service providers and wireless users may face various obstacles. For example, mobile service subscribers can be hesitant to embrace new technologies with which they are not familiar. The service providers must therefore convince users of the benefits of using VoIP-enabled mobile devices, including dual-mode mobile devices such as those capable of functioning on both GSM and UMA networks. It must be simple for consumers to configure their mobile device to access their local wireless LAN in a secure, reliable manner. For example, using current technology, a technician may have to assist a customer to determine whether the customer's wireless access point has connectivity to a larger network. A customer using an IP-based wireless telecommunications enabled mobile device may not know why her mobile device is unable to place calls via her wireless access point. Alternatively, if a customer has network connectivity but still cannot place VoIP calls, it may be difficult for a customer to know whether he properly configured his access point to connect to his service provider.

The need exists for a system that overcomes the above problems, as well as one that provides additional benefits, such as simplifying the process of configuring, troubleshooting, and acquiring details about VoIP connectivity. Overall, the examples herein of some prior or related systems and their associated limitations are intended to be illustrative and not exclusive. Other limitations of existing or prior systems will become apparent to those of skill in the art upon reading the following Detailed Description

### BRIEF DESCRIPTION OF THE DRAWINGS

FIG. 1 illustrates aspects of a sample network system that allows VoIP-based communications in conjunction with a public switched telephone network (PSTN).

FIG. 2 illustrates an example converged wireless network system that combines a cellular network with an IP-based wireless telecommunications network.

FIG. 3 illustrates an embodiment of the access point

FIG. 4 illustrates an indication of wireless access on a mobile device

FIG. 5 illustrates an indication of IP-based wireless telecommunications availability on a mobile device

FIG. 6 is a logic flow diagram illustrating a possible power-on sequence in an access point.

FIGS. 7A and 7B show several screens of a user interface for a mobile device as it moves within range of various access points.

FIG. 8 is a flow diagram showing an example of a routine for making a pricing indication decision and providing a related indication to the mobile device.

### DETAILED DESCRIPTION

The following description provides specific details for a thorough understanding of, and enabling description for, various embodiments of the technology. One skilled in the art will understand that the technology may be practiced without these details. In some instances, well-known structures and functions have not been shown or described in detail to avoid unnecessarily obscuring the description of the embodiments of the technology. It is intended that the terminology used in the description presented below be interpreted in its broadest reasonable manner, even though it is being used in conjunction with a detailed description of certain embodiments of the technology. Although certain terms may be emphasized below, any terminology intended to be interpreted in any restricted manner will be overtly and specifically defined as such in this Detailed Description section.

### I. Sample Network Configurations

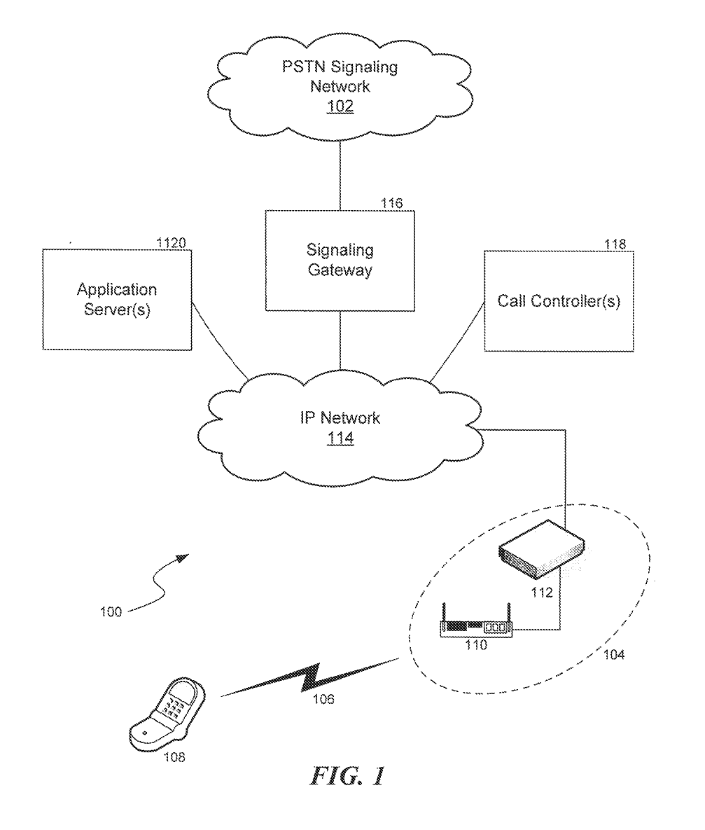

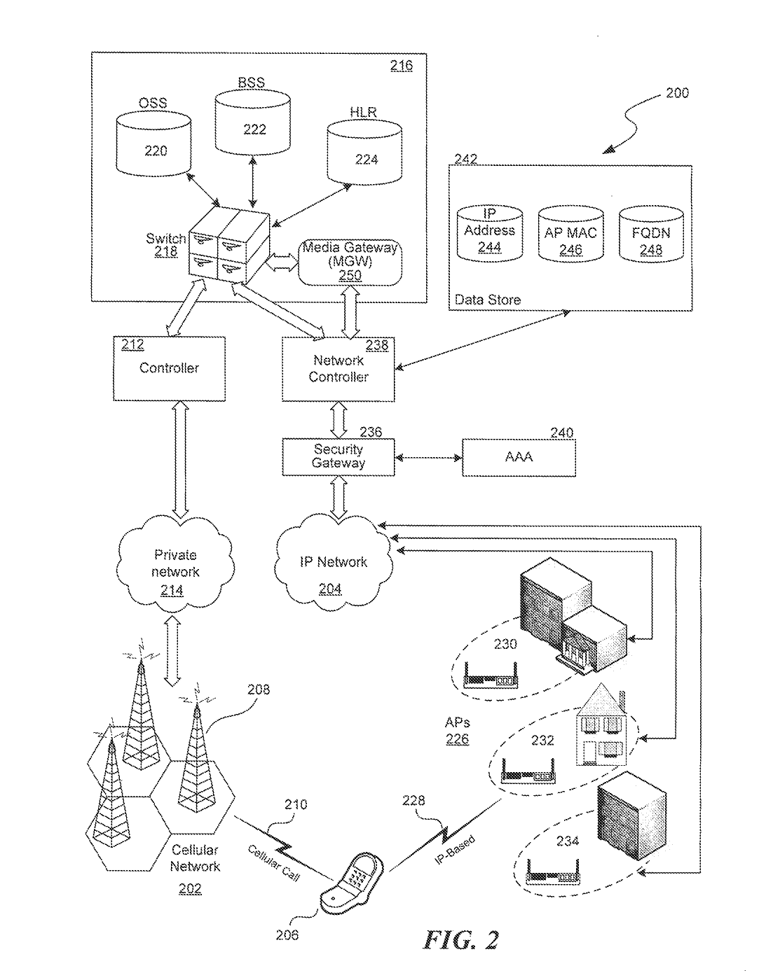

FIGS. 1 and 2 show sample network system configurations in which aspects of a service availability and pricing indication facility can be implemented in accordance with various embodiments. In general, one aspect of the service availability and pricing indication facility relates to making decisions about service availability and service pricing within a telecommunications network that is configured for both IP-based and non-IP based communications (such as a UMA or VoIP network). Another aspect of the service availability and pricing indication facility relates to providing indications of pricing and service availability decisions to a user of a mobile device, so that user may make informed decisions about how, when, and where to use the mobile device within the telecommunications network.

In general, some network elements are described herein as performing certain functions. Those functions could be performed by other elements in the same or differing networks, which could reduce the number of network elements. Alternatively or additionally, network elements performing those functions could be replaced by two or more elements to perform portions of those functions.

FIG. 1 illustrates aspects of a sample network system 100 that allows VoIP-based communications in conjunction with a public switched telephone network (PSTN) 102. The system 100 includes at least one wireless access point 104. The access point 104 may be public or private, and may be located, for example, in a subscriber's residence (e.g., home, apartment or other residence), in a public location (e.g., coffee shops, retail stores, libraries, or schools) or in corporate or other private locations. In the sample system of FIG. 1, the access point 104 can accept communications 106 from at least one suitably configured telecommunications device 108 (e.g., a VoIP device). Various examples of network technology that may be involved in communicating between the telecommunications device 108 and the access point 104 include the IEEE 802.16 (WiMAX), IEEE 802.20 Mobile Broadband Wireless Access (MBWA), Ultra Wideband (UWB), 802.11 wireless fidelity (Wi-Fi), Bluetooth standards, or other similar standards. The access point 104 includes a wireless router 110 and a broadband modem 112 that enable connection to an Internet Protocol (IP) network 114. The IP network 114 may comprise one or more public networks, private networks, or combination of public and private networks.

In a communication or set of communications 106, the access point 104 receives IP packets from the telecommunications device 108. These IP packets are then transported through the IP network 114 to a signaling gateway 116, which in the example of FIG. 1, is operated by a telecommunications service provider. At the signaling gateway 116, the IP packets are converted to a traditional phone service signal. The phone service signal is then conveyed to a recipient via the PSTN 102.

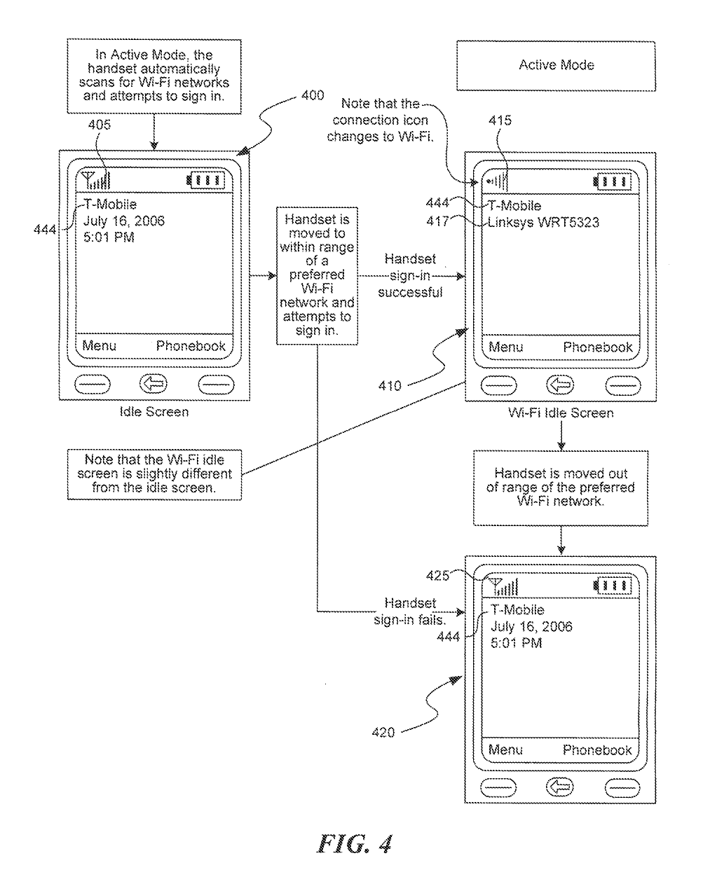

The network system 100 of FIG. 1 also includes a call controller 118 that provides call logic and call control functions for communications sent through the system and an application server 120 that provides logic and execution of one or more applications or services offered by the telecommunications service provider, such as applications that implement various access and security rules. In some embodiments, aspects of the service availability and pricing indication facility may be implemented at the call controller 118 and/or application server 120, as described in more detail below with respect to FIGS. 4-8. In this example, a telecommunication service provider manages both the call controller 118 and the application server 120.

FIG. 2 illustrates a sample network system 200 in which aspects of the service availability and pricing indication facility can be implemented within a cellular telephone-type network. In general, with respect to the network system described in FIG. 2, because the same cellular protocols are used in communications involving IP access points as with traditional radio towers, the cellular service provider maintains a large degree of system compatibility even though using an IP-based network. For example, the various systems of the cellular service provider that deliver content and handle mobility may not even need to be aware that a subscriber's mobile device is on an IP-based wireless telecommunications network. Instead, the various systems of the cellular service provider assume the mobile device is on its native cellular network. The IP network is, therefore, abstracted with respect to the cellular network, regardless of whether the mobile device connects to the cellular network via a base station (e.g., for licensed spectrum access) or a wireless access point (e.g., for licensed, semilicensed and/or unlicensed spectrum access—such as spectrums for IP-based telecommunications). Likewise, at a protocol level, because the same cellular protocols are used in communications involving the IP access points as with traditional radio towers, the cellular service provider maintains a large degree of system compatibility even though using an IP-based network.

Referring to FIG. 2, a sample network system 200 combines a cellular telephone network 202 (such as a GSM network) and an IP network 204 in a UMA-type configuration that provides service to the user of a mobile device 206. Such service may include voice services, and also supplementary services like call forwarding and call waiting, text messaging services (e.g., SMS) and data-based services like ring tone downloads, game downloads, picture messaging, email and web browsing. Further, since the mobile device 206 is connected to an IP network, all manner of data services available over such networks may be provided to the mobile device 206. In this example, the mobile device 206 is a dual-mode device, which can take advantage of both IP-based and non-IP-based features that the network system 200 provides.

In general, the described network system 200 accepts registration requests and communication connections from the mobile device 206. The accepted registration requests can be requests to either the cellular telephone network 202 or to the IP-based network 204. Accordingly, to handle requests to the cellular telephone network 202, the cellular telephone network 202 includes one or more cell towers 208 that are configured to accept cellular communications 210 from the mobile device 206. The cell towers 208 are connected to a base station controller 212 (such as a base station controller/radio network controller (BSC/RNC)) via a private network 214. The private network 214 can include a variety of connections (not shown) such as T1 lines, a wide area network (WAN), a local area network (LAN), various network switches, and other similar components.

The base station controller 212 controls communication traffic to a carrier core network 216, where all communications are managed (including both cellular and IP-based). Components of the carrier core network 216 in this example include a switch (e.g., mobile switching center or MSC) 218, which is configured to control data/call flows and perform load balancing, as well as other functions. The carrier core network 216 may also include a variety of system databases such as an operation support subsystem (OSS) database 220, a business support system (BSS) database 222, and home location register (HLR) 224 or other central subscriber database that contains details of a carrier's subscribers for billing, call logging, etc.

The sample network system 200 of FIG. 2 further includes one or more access points 226 that can accept IP-based communications 228 from the mobile device 206. For example, each access point 226 can be configured as part of a wireless network in one or more locations such as a public network 230, a home network 232, or a private business network 234. Each access point 226 is coupled to the IP network 204 through, for example, a broadband connection (not shown) such as a DSL (Digital Subscriber Line) modem, a cable modem, a satellite modem, or any other broadband device.

When the mobile device 206 attempts to access the IP network 204 (i.e., to initiate an IP-based communication), information (e.g., data, voice, SMS, etc.) is initially formatted in the cellular system's 202 native protocol and then encapsulated into Internet Protocol (IP) packets, which are transmitted to the access point 226 and routed through the IP network 204 to a security gateway 236. In contrast to non-IP communication requests, such transmissions bypass the cellular telephone system's 202 existing network of radio towers. The security gateway 236 controls access to a network controller 238, which communicates with a data store 240 for logging and accessing communications data. Thus, one function of the network controller 238 is to manage access to the carrier network 216 when dealing with an IP-based communication (in a similar manner to that performed by the base station controller 212 for a non-IP-based communication).

In one example, authentication of a request for access by the mobile device 206 over the IP network 204 is handled by the security gateway 236, which communicates with an authentication, access and authorization (AAA) module 240 that is most likely associated with the carrier network 216. Challenges and responses to requests for access by the mobile device 206 are communicated between the HLR 224 and the AAA module 242. When authorization is granted, the security gateway 236 communicates the assignment of an IP address to the mobile device 206 that requested access. Once the security gateway 236 passes the IP address to the mobile device 206, the public IP address assigned to the mobile device 206 is passed to the network controller 238.

In another authorization example, upon receiving an identifier from the mobile device 206, the network controller 238 may query the data store 242 to determine if the mobile device 206 is authorized for accessing the IP network 204. Sample identifiers that may be utilized to determine access include a media access control (MAC) address associated with an access point, a mobile device or subscriber identifier (such as an International Mobile Subscriber Identifier (IMSI)), an Internet Protocol (IP) address (or “Public IP address”) associated with the access point, a fully qualified domain name (FQDN), or other similar types of information. The data store 242 may be a single database, table, or list, or a combination of databases, tables, or lists, such as one for IP addresses 244, one of MAC addresses 246, and one for FQDNs 248. The data store 242 may include “blocked” identifiers as well as “authorized” identifiers. Authorized accesses to the IP-based wireless telecommunications network may be maintained by the network controller 238 in an authorized session table or similar data construct.

In some cases, the signaling portion of a communication (e.g., the portion of the communication that governs various overhead aspects of the communication such as, for example, when the call starts, when the call stops, initiating a telephone ring, etc.) is routed through the network controller 238 to the switch 218, while the voice bearer portion of the communication (e.g., the portion of the communication that contains the actual content (either data or voice information) of the communication) is routed through the network controller 238 to a media gateway 250. In other words, the media gateway 250 controls the content flow between the service provider and the mobile device 206, while the switch 218 controls the signaling flow (or controls overhead-related flow) between the service provider and the mobile device 216.

The service availability and pricing indication facility can be implemented in environments other than the environments depicted in FIGS. 1 and 2. For example, the telecommunications device/mobile device could be a non-IP-enabled mobile phone that connects to an IP-enabled femtocell that is connected to an IP-based telecommunications network over an IP network. As a second example, the telecommunications device/mobile device could be an analog telephone that connects to an IP-enabled terminal adaptor that is connected to an IP-based telecommunications network over an IP network. As a third example, the telecommunications device/mobile device could be an IP-enabled softmobile (e.g., a personal computer having a USB device with an embedded SIM and UMA softphone application) that is connected to an IP-based telecommunications network over an IP network. The telecommunications device/mobile device may also include other devices, such as wearable computers, devices that perform monitoring or tracking functions, and any other device (or combination of devices) that is IP-enabled, either in hardware, software, or a combination of both hardware and software. Therefore, those of skill in the art will understand that various configurations are possible and that the facility can be implemented in a wide variety of environments.

### II. Indication of IP-Based Wireless Telecommunications Service Availability

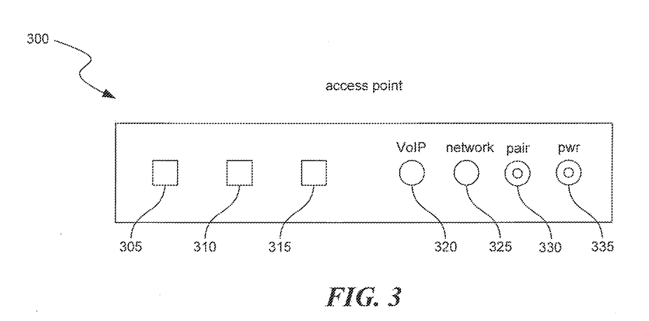

FIG. 3 is a view of the front panel of a representative access point 300 that is suitable for use in an IP-based wireless telecommunications system. The access point 300 includes an interface to provide a visual indication to an operator or user as to the status of the access point 300 and to enable the operator or user to implement certain access point features. Such interface may comprise connection LEDs 305, 310, and 315, VoIP access LED 320, network connectivity LED 325, pairing button/LED 330, and power button/LED 335. While LEDs are utilized in the access point display in the present example, those skilled in the art will appreciate that other display technology, such as LCDs, may be used to convey status information to a user. Moreover switches or other signaling mechanisms may be used in place of buttons to allow a user to implement certain access point features. The operation of various interface elements will be discussed in turn below.

Connection LEDs 305, 310, and 315 indicate the number of currently connected mobile devices to the access point 300. That is, a connection LED will be lit when the access point 300 is paired with a mobile device and is currently being used by the mobile device to support an IP-based communication from a mobile device (e.g., a VoIP call). While only three LEDs are depicted in FIG. 3, a greater or lesser number of LEDs may be used depending on the number of simultaneous connections that are supported by the access point 300. When the maximum number of simultaneous connections that can be supported by the access point 300 has been reached, all of the connection LEDs on the access point 300 will be lit. As each mobile device terminates their connection with the access point 300, the corresponding connection LED will be turned off. The LEDs may have a one-to-one correspondence with each connection (i.e., each LED represents one connection), a one-to-many correspondence with each connection (e.g., each LED represents two or more connections), or may represent a relative level of connections through the access point (i.e., the LEDs may light in accordance with a capacity algorithm).

In the example of FIG. 3, two elements of the access point interface are used to convey network status to a user/subscriber. VoIP access LED 320 indicates whether VoIP service is available on the access point 300. VoIP access is available when the access point 300 can access a network controller (such as the network controller 238 of FIG. 2). The VoIP access LED 320 may turn different colors depending on availability, such as green when service is available and red if service is not available. Network connectivity LED 325 indicates whether network access is available at this access point 300. Network connectivity means that the access point 300 is able to obtain valid IP and DNS addresses and access resources associated with these addresses. If network access is available, then the network connectivity LED 325 is green, for example, whereas it is red if network access is unavailable. In this example, it is possible for network connectivity LED 325 to be green even if the VoIP access LED 320 is red. As an alternative to the lighting scheme described above, the access point can be configured with other light configurations, such as a single three-color LED that is red when no Internet connection is available, yellow for Internet connection but no UMA access, and green if there is UMA availability.

In the example of FIG. 3, the access point interface has two elements that the operator or user can utilize to implement certain functionality as well as convey access point status. These include a pairing button/LED 330 and a power button LED 335. When pressed, the pairing button/LED 330 commences a process of pairing a mobile device to the access point 300, which allows a VoIP-enabled mobile device to be configured to login to the access point 300. In the given example, when an operator or user of the access point presses the pairing button/LED 330, this signals the access point 300 to enter a non-secure mode. While in this mode, a user of a mobile device can configure the mobile device to login to the access point 300, even after the access point 300 returns to secure mode. When the pairing button/LED 330 is blinking, it means that a pairing procedure is in progress. When the pairing button/LED 330 stops blinking and remains lit, it indicates that the pairing process is complete. When pressed, the power button/LED 335 toggles the power of the access point 300. If the power is on when it is pressed, the access point 300 will shut down, and vice versa. When green, the power button/LED 335 indicates the access point 300 is on, whereas it is unlit when the access point 300 is off.

In some embodiments, indications about network access and VoIP availability may be made by turning LEDs on or off, by causing an LED to blink on and off, by means of different colors or types of lights, by means of text on an LCD panel, or by some other means. In some embodiments, the method by which the access point provides indications is not restricted to using a user-visible interface on an access point. Instead of, or in addition to, the access point interface, a visual or aural indication may be provided to a user via a mobile device, a personal computer, or other device that can receive and communicate information from the access point.

As an example of an additional way of providing network status to a user of a dual-mode wireless telecommunications device (such as the mobile device 206 of FIG. 2), FIG. 4 depicts several screen shots of a user interface for the dual-mode device. When the dual-mode device is within communication range of a cellular network, but not within communication range of an access point for an IP-based wireless telecommunications network, the interface provides a cellular network icon 405 and 425 to communicate to the user that the mobile station has connected to a cellular radio network, as shown in screens 400 and 420, respectively. In this example, the cellular network icon 405 and 425 also represents the relative signal strength of the cellular network signal by the number of bars that are displayed in the icon.

As shown in screen 410, when the device comes within communication range of an IP-based wireless telecommunications network access point that it has been configured to access, the mobile device will automatically attempt to login to the access point. If the login succeeds, a “Wi-Fi” network icon 415 (or similar icon depending on the type of connection—as connection types other than Wi-Fi are possible such as IEEE 802.16 (“WiMAX”), IEEE 802.20 Mobile Broadband Wireless Access (MBWA), Ultra Wideband (UWB), 802.11 wireless fidelity (“Wi-Fi”), Bluetooth, etc.) is displayed on the screen. The “Wi-Fi” network icon 415 indicates that the device is able to place a call or perform other communications using the access point, should the user desire to do so. The “Wi-Fi” network icon 415 may also be used to represent the relative signal strength of the access point signal by the number of bars displayed in the icon. When the device has logged into the access point, the device may also display the service set identifier (SSID) 417 of the access point, as shown in screen 410. While not shown, in some embodiments, as an alternative to displaying the SSID 417 of the access point on the screen 410, the user can configure preferences that allow the interface to display a user specified name for that access point (e.g., “Home” or “Julie's,” etc.). As shown in all three screens 400, 410 and 420, the device may also display the enhanced operator name string (EONS) 444, so that the user will know the carrier's network to which the mobile device has connected.

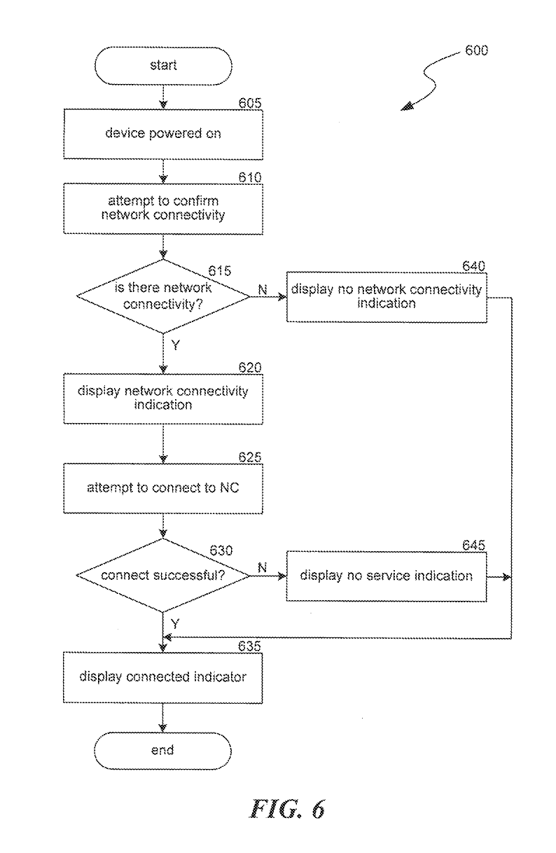

If the dual mode device is within communication range of an access point, but the access point is unable to provide connectivity to the mobile device (as described in more detail with respect to FIG. 6), the device interface may present a dialog to allow the user to configure the device to login to the network access point, or it may indicate reasons why the mobile device is unable to login to the access point.

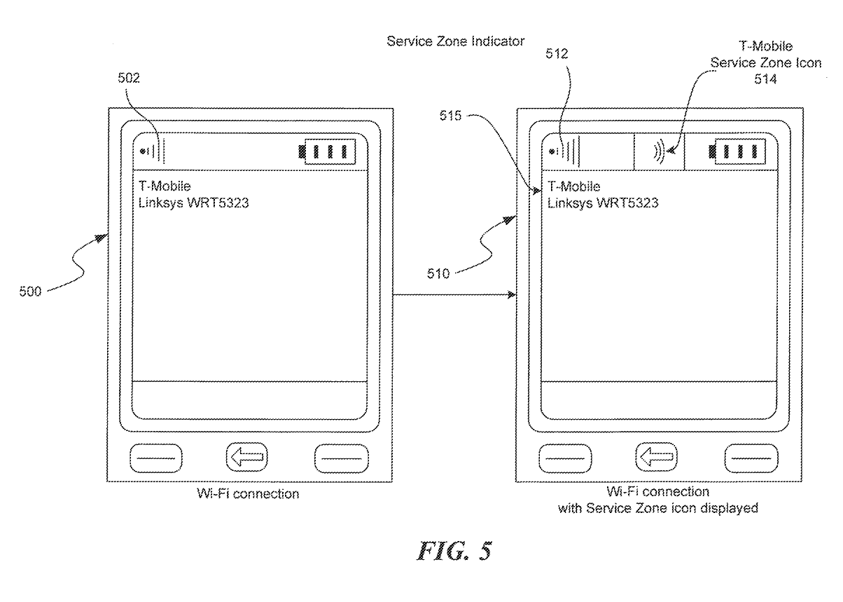

FIG. 5 illustrates two screens, screens 500 and 510, which demonstrate two different levels of IP service availability. While both screens 500 and 510 provide an icon-based indication 502 and 512 of IP service availability, screen 510 shows an additional icon 514 that indicates that the access point within range is associated with the same cellular service provider as the device. In such a situation, the system may be able to provide automatic pairing or a security exchange. Accordingly, when this icon 514 is displayed, the user can assume that the mobile device may automatically place calls using the IP-based wireless telecommunications network rather than a cellular radio network. With respect to FIGS. 4 and 5, in some embodiments, the method by which the device provides indications is not restricted to using a user-visible interface. For example, instead of, or in addition to, the screen based user interface, a visual or aural indication may be provided to a user via the mobile device, a personal computer, or other device.

FIG. 6 is a logic flow diagram illustrating a power-on sequence 600 in an access point. At block 605, the access point is powered on by a user or by a network administrator. At a block 610, the access point attempts to connect to a gateway in the IP Access Network. The connection request might comprise a DHCP request, a ping of a remote device on the network, a request of a resource on the network, logging into a security gateway, or a similar test that can indicate the status of network connectivity. At block 615, a test is made to determine if the access point has established network connectivity. If the access point is unable to connect to the IP Access Network, then at block 640 the access point turns network LED red. The power-on sequence then terminates, as the user or system operator must troubleshoot to determine why network connectivity cannot be established. The mobile device may be unable to login to the access point for a variety of reasons, including, but not limited to: the access point is not configured to allow the mobile device to login, the access point is unable to support an additional mobile device, or the access point may be malfunctioning. For example, the mobile device may be unable to login when a customer has correctly configured the mobile device to connect to the customer's access point but, for example, the access point is unable to connect to the customer's Internet Service Provider (ISP).

If the access point is able to connect to IP Access Network, at a block 620 the access point turns network LED green to display to the user that IP network connectivity has been established. After achieving IP network connectivity, the power-on sequence proceeds to block 625 where the access point attempts to connect to a security gateway and/or network controller. To request registration, the access point makes a request to create an authorization protocol, such as an extensible authorization protocol for GSM subscriber identity module (EAP-SIM), connection with the network controller.

At block 630, a test is made to determine whether a connection has been achieved with the security gateway and/or network controller. If a connection with the security gateway/network controller cannot be achieved, at a block 645 the access point turns on the IP-based network LED. The power-on sequence then terminates, as the user or system operator must troubleshoot to determine why IP-based network connectivity cannot be established (in the meantime, the network may establish a dummy security gateway that would not require credentialing). If the access point is able to connect to the security gateway/network network controller, at a block 635 the access point changes the color of IP-based network LED to green to display to the user that IP-based network connectivity has been established. Another step that the access point may take is to determine if there is enough bandwidth to exchange sufficient data to enable a voice call (with the awareness/supervision of the SGW). If the bandwidth is sufficient, then the access point changes the color of the VoIP LED to green, indicating that such calls may be made.

It will be appreciated that the access point might periodically repeat one or more of the power-on sequence steps and update the interface lights accordingly so that the lights accurately indicate the status of the access point. The steps may be repeated on an automated basis, at the request of a system administrator, or at the request of a user. Various embodiments of this logic flow may contain these steps in a different order, may exclude some steps, add other steps, or change the logic flow in some combination of the above.

The interface lights on the access point give useful information to both users and customer support personnel. For example, if a customer is performing an initial configuration of access point, he may not know why the access point is not working. By providing an indication to the customer that network access cannot be established by turning network access LED red, the customer can then follow instructions related to resolving a no network access condition. Such instructions might suggest he should check to make sure he configured the cables correctly. As a result, he might resolve the issue more quickly than he would have without information from the LEDs. As another example, a customer may find that she cannot make phone calls using VoIP. Upon inspecting the access point she is using, she can observe that there is no VoIP availability. As a result, she can contact her service provider to determine why the VoIP service appears unavailable from her access point. Since there is an indicator showing that network access is available, but VoIP service is not, neither she nor the customer service representative will need to spend time investigating whether the access point has network access. They can thus quickly focus their investigation on the availability of VoIP service.

Through these indicators, an access point can communicate information about its status to a user. As a result, a customer can provide useful information to a customer service representative, or the customers can use this information to troubleshoot the problem on their own. The information provided by the indicators narrows the range of possible problems and can reduce the amount of time either a customer or customer service representative spends resolving an issue.

### III. Location-Based Pricing for IP-Based Wireless Telecommunications Service

In addition to being interested in network status, a user of a dual-mode wireless telecommunications device may also be interested in learning about location-based pricing options for a given telecommunications transaction, especially in the case where the cost to a user of using the device to make an IP-based telecommunications transaction is based, at least in part, on location and/or the particular network components being used to access the IP network. For example, when using Wi-Fi access points to connect to the network, a user may be charged according to the actual Wi-Fi access point being used. To further illustrate, according to the specific service plan that the user has selected, a user with her own access point at home may only be charged when accessing the IP network through an access point other than the one that is in her home. In another example, certain access point owners, such as retailers, may partner with a mobile telecommunications service provider to offer use of their own access points at no charge (e.g., as a part of a promotion) to users who may otherwise pay a per-transaction charge for communication transactions involving such an access point.

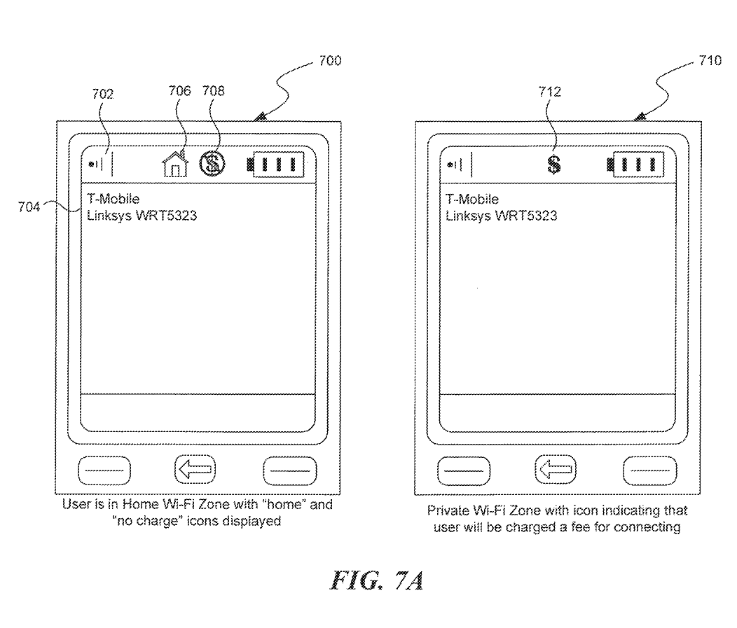

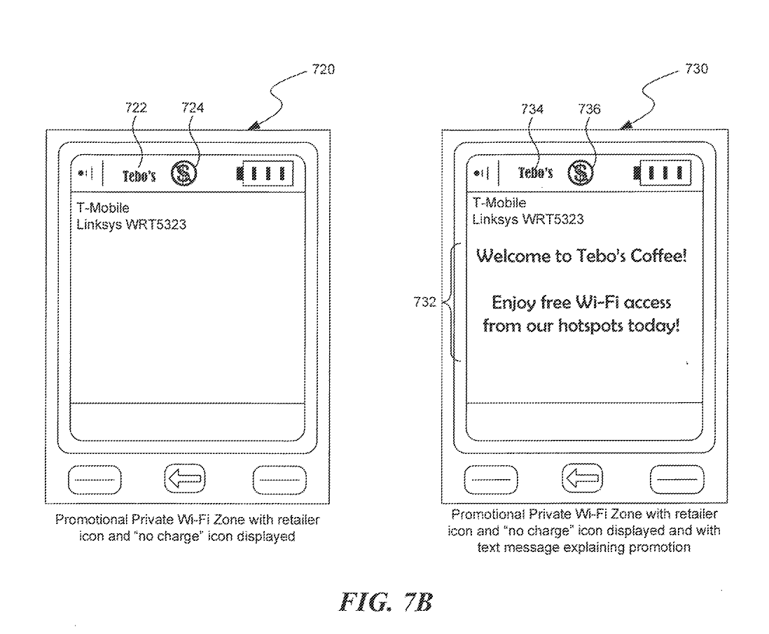

To help a user understand when and how much he or she will be charged for partaking in an IP-based telecommunications transaction the user's device may include a user interface that provides such information, as depicted in FIGS. 7A and 7B. FIGS. 7A and 7B show several screens of a user interface for a mobile device as it moves through a range of access point zones. In particular, each screen provides information about how much a user will be charged when making a communication using the respective access point.

Referring to FIG. 7A, screen 700 displays a “Wi-Fi” network icon 702 (or similar icon depending on the type of connection), which indicates that the mobile device is within range of an access point through which it may be able to place an IP-based communication, should the user desire to do so. The mobile device may also display the service set identifier (SSID) of the available access point as shown by label 704. An icon 706 may be displayed to indicate that the mobile device is within a “home” zone. In other words, the mobile device may currently be located within the user's residence or within some other range or location that has been designated as the user's “home area” (e.g., in which the user has designated as a personal Wi-Fi network and/or access point). Screen 700 also displays an example of a “no charge” icon 708 that provides to the user an indication that the user will not be charged for communications made through the currently available access point.

Screen 710 of FIG. 7A shows that the user has moved into a location where access to the IP network is still available, but where the user will be charged for use of available access point. Accordingly, a “dollar sign” icon 712 is displayed on the screen 710.

The screens 720 and 730 of FIG. 7B show that the user has moved into a location where access to the IP network is available via a private access point, in this case an access point owned by a retailer (Tebo's Coffee). The screen 720 provides this information to the user via a “Tebo's” icon 722. In this particular example, the retailer (Tebo's) has joined with the network carrier to provide a promotion where customers of the network carrier can use Tebo's Wi-Fi access points without incurring extra charges. Accordingly, screen 720 displays a “no charge” icon 724 along with the Tebo's icon 722. Screen 730 is similar to screen 720 except that an additional text message 732 is displayed, explaining the promotion to the user. In some embodiments, this type of message (i.e., indicating the pricing for network access) may be automatically displayed along with one or more icons (e.g., icons 734 and 736), or may be displayed at the option of the user when the user selects to view “more information” about their current network status, etc. In addition to explaining promotions, such as shown in this particular example, a similar text message may be used to display other status/price information (e.g., user is currently in/out of home area, user will be charged $X.XX to access the network through the current access point, user is currently on XYZ's Wi-Fi network, etc.).

With respect to FIGS. 7A and 7B, in some embodiments, the method by which the device provides indications is not restricted to using a user-visible interface. For example, instead of, or in addition to, the screen based user interface, a visual or aural indication may be provided to a user via the mobile device, a personal computer, or other device.

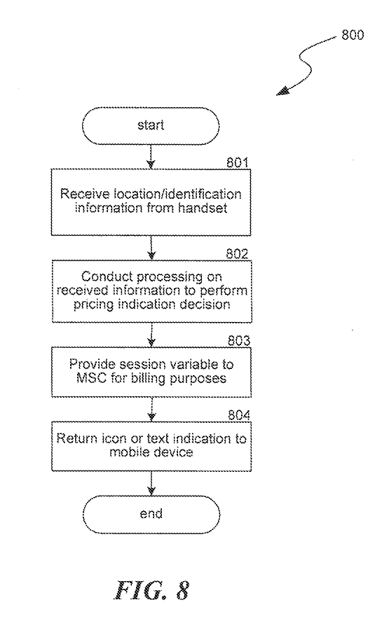

FIG. 8 is a flow diagram showing a high level routine 800 which allows the network service provider system to make a current pricing determination for a user's mobile device based on the user's current location and then send an indication of the pricing determination back to the mobile device. The routine of FIG. 8 takes place, for example, in a network component associated with the carrier/service provider system, such as the network controller 238 of FIG. 2. The routine 800 of FIG. 8 already assumes that the user is within range of an access point (e.g., a Wi-Fi access point) and that network connectivity is available from this access point (see, e.g., FIG. 6 and associated textual description).

At block 801 the routine receives information from the mobile device or from the access point that can be used in making a pricing determination. The types of information that the routine receives at block 801 may include information such as a subscriber identifier (e.g., MSISDN or IMSI), current mobile device location information (e.g., GIS coordinates), information about the mobile service cells in the area (e.g., GSM cell ID as recorded by the mobile device), MAC address(es) or range(s) related to the access point, the SSID for the access point, the IP address from which the communication is coming from, a cell global identifier (CGI), etc. Some or all of this information may be gathered by the mobile device and communicated to the appropriate carrier network component(s) during a conventional registration process. For example, the MAC information and the SSID for the access point may be gathered by the mobile device during its initial handshake with the access point. Some of this information may also be obtained directly from the access point.

Once the routine 800 has received the appropriate information (as described in block 801), the routine 800 proceeds, at block 802, to process the received information to make a pricing indication decision. This may include conducting one or more database lookups. For example, a carrier network database (such as the data store 242 of FIG. 2) may store location definition data for each user consisting of mappings between users and locations. This information may be based on the user's selected service plan or may be based on other user preferences, such as preferences gathered during a user registration process. The carrier network database may also store promotions data consisting of mappings between access points and special promotions, etc. The carrier network database may also store service zone data consisting of mappings between access points and service zones (e.g., zones sharing a common characteristic, such as association with a particular business). Accordingly, at block 802, the routine 800 may look at the received location/identification information and compare it with user specific location information, promotion information, or service zone information in the database. Additional details regarding location based processing may be found in commonly owned PCT Application No. ______ (Attorney Reference No. 31419-8035.WO00), filed on Oct. 22, 2007, entitled “TWO STAGE MOBILE DEVICE GEOGRAPHIC LOCATION DETERMINATION” and information about service zones may be found in commonly owned PCT Application No. ______ (Attorney Reference No. 31419-8034.WO00), filed on Oct. 22, 2007, entitled “SYSTEM AND METHOD FOR DETERMINING A SUBSCRIBER′S ZONE INFORMATION.” These applications are herein incorporated by reference.

The result of this processing in block 802 may include a session variable (e.g., a “billing zone” or other variable) to be used for communications made from that access point. Thus, at block 803, the routine 800 passes this session variable to the switch or other carrier network component for billing purposes. The result of the processing at block 802 may also result in the generation of an icon indicator or text that shows the result of the pricing indication decision. At block 804 the routine returns an icon or text back to the mobile device or transmits a code reflective an icon or text to the mobile device. The mobile device may be configured (e.g., as part of the 3GPP UMA standard) to retrieve icon indicator data from the network at the time of registering with the network. The icon indicator and/or text can then be displayed to the user of the mobile device, for example, on an idle screen as shown in FIGS. 7A and 7B

### IV. Conclusion

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the system is not intended to be exhaustive or to limit the system to the precise form disclosed above. While specific embodiments of, and examples for, the system are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times. Further any specific numbers noted herein are only examples: alternative implementations may employ differing values or ranges.

The teachings of the methods and system provided herein can be applied to other systems, not necessarily the system described above. The elements and acts of the various embodiments described above can be combined to provide further embodiments.

Any patents and applications and other references noted above, including any that may be listed in accompanying filing papers, are incorporated herein by reference. Aspects of the technology can be modified, if necessary, to employ the systems, functions, and concepts of the various references described above to provide yet further embodiments of the technology.

These and other changes can be made to the invention in light of the above Detailed Description. While the above description describes certain embodiments of the technology, and describes the best mode contemplated, no matter how detailed the above appears in text, the invention can be practiced in many ways. Details of the system may vary considerably in its implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the technology are presented below in certain claim forms, the inventors contemplate the various aspects of the technology in any number of claim forms. For example, while only one aspect of the invention is recited as embodied in a computer-readable medium, other aspects may likewise be embodied in a computer-readable medium. Accordingly, the inventors reserve the right to add additional claims after filing the application to pursue such additional claim forms for other aspects of the technology.

I/We claim:

1. A method of providing information about the pricing of services to a subscriber of mobile communications services, wherein the mobile communications services include IP-based services and non-IP-based services and are implemented, at least in part, via a service provider network, the method comprising:
receiving a communication from a mobile device associated with a subscriber through a network access point, the communication including information about a current or near current location of the mobile device;
comparing the received location information of the mobile device with a service plan associated with the subscriber to make a determination of pricing associated with service through the access point, the determination of pricing based at least in part on the current or near current location of the mobile device; and
providing information to the mobile device that allows the mobile device to display an indication to the subscriber of the determined pricing of service through the network access point.

2. A method of providing information about the availability of service in a mobile device to a subscriber, wherein the mobile device receives IP-based and non-IP-based mobile communications services from a service provider network, the method comprising:
detecting the presence of a network access point from a mobile device;
establishing connectivity with the network access point;
receiving an indication from the network access point that the access point has sufficient capacity to support voice-over-IP (VoIP) service; and
if the network access point has sufficient capacity to support VoIP service, displaying a visual indication on the mobile device to the subscriber that service is available through the network access point.
